(19) United States
(12) Patent Application Publication
(10) Pub. No.: US 2015/0047876 A1
(43) Pub. Date: Feb. 19, 2015

(54) BUSBAR

(71) Applicant: ALBUS INDUSTRIES PTY LTD, Maddington (AU)

(72) Inventor: Richard Lionel De Laeter, Maddington (AU)

(21) Appl. No.: 14/386,042

(22) PCT Filed: Mar. 19, 2013
(86) PCT No.: PCT/AU2013/000277

§ 371 Date: Sep. 18, 2014

(30) Foreign Application Priority Data
Mar. 20, 2012 (AU) 2012901127

(51) Int. Cl. H01B 7/38; C25D 5/12; H01B 3/40; H01B 13/06; H01B 5/02; H01B 7/02; H01B 13/32; H01B 13/30; C25D 5/34; H01B 1/02

(52) U.S. Cl. CPC H01B 7/38; C25D 5/34; C25D 5/12; H01B 3/40; H01B 1/023; H01B 5/02; H01B 7/02; H01B 13/321; H01B 13/30; H01B 13/06
USPC 174/119 R; 205/185; 205/181; 427/58

(57) ABSTRACT

A busbar 10, for use in electrical distribution, is disclosed. The busbar 10 arranged to have an electrically conductive barrier 22 disposed about at least a first portion 20 of the busbar surface 13 for limiting the formation of an oxide layer on the busbar 10. In a further aspect of the present invention the busbar 10 is arranged to have an electrically insulating barrier 26 disposed about at least a second portion 24 of the busbar 10 surface 13 for limiting undesired electrical connection with the busbar 10. The present invention provides a pre-insulated busbar 10 which can be subsequently shaped or prepared without compromising the insulating barrier 26 or the conductive barrier 22. The present invention provides a busbar 10 having improved safety, speed of fitting, and handling characteristics.

### FIELD OF THE INVENTION

The present invention relates to an apparatus for electrical connection and in particular to a busbar for use in an electrical distribution apparatus such as a switch board. Further, the present invention relates to a pre-insulated busbar.

### BACKGROUND

It is known to use a busbar for electrical power distribution in switch boards and other electrical apparatus. A naked busbar typically comprises a plain length of highly conductive metal, such as copper or aluminium, for conducting and distributing electricity.

Busbars are often configured as a flat strip to provide a high surface area to volume ratio which assists in effective heat dissipation. Busbars are often used to conduct dangerous voltages and high currents, in order to protect against accidental electrocution, short circuits or internal arcing faults, insulation of a naked busbar is carried out as an additional step in the assembly of a switch board.

A busbar will often need to be shaped or prepared in some way (i.e. holes drilled) in order for the busbar to fit a particular switch board, electrical apparatus or connection. Prior art busbars are supplied in a naked state and it is not known for a busbar to be insulated prior to shaping or fabricating the busbar.

Known techniques for insulating a naked busbar are carried out after the busbar has been shaped and/or otherwise prepared. These techniques include heat shrink sleeving, PVC (or similar) rigid sleeving or powder coating. Heat shrink sleeving is expensive and prone to becoming fragile and brittle over time. Moreover this method of insulation is time consuming as a naked busbar must first be shaped and assembled into a switchboard, then disassembled, before being reassembled with an insulating heat shrink fitted. PVC sleeving has good mechanical strength and is generally cheaper than heat shrink sleeving however the thickness of the PVC sleeve creates difficulties when fitting a PVC sleeved busbar into a switch board having standard busbar supports. Known powder coating techniques requires a naked busbar to be at least partly assembled, then taken apart and the connecting surfaces masked with a heat resistant tape before a powder coating is applied.

The metal materials used in a busbar include copper or aluminium. Both of these materials are reactive to oxygen in the atmosphere whereby a hard oxide layer naturally forms upon a naked metal surface. Oxide layers form quickly and have a high resistance to current flow and interfere with the optimal functioning of a busbar which can lead to failure of connections over time.

It is also known to plate a copper busbar with tin to limit the formation of an oxide layer. In use, an oxide layer on a busbar must be punctured and preferably used with a contact lubricant to reduce electrical resistance when connecting the busbar to other busbars or electrical apparatus.

In Australia the prevalent material used in a busbar is copper. Copper has a high electrical conductivity, good corrosion resistance and is a soft metal that is relatively easy to work with. However, the weight and high cost of copper are factors which are problematic.

Aluminium material is less expensive than copper however the cross sectional area of an aluminium busbar must be around 60% greater than an equivalent copper busbar to achieve the same thermal rating. The oxide layer that forms on an aluminium metal surface is self limiting to around a thickness of 10 μm and is electrically resistive causing failure of connections over time. For this reason prior art aluminium busbars must be treated more carefully than is necessary for copper busbars. After shaping and/or preparing a prior art naked aluminium busbar the connecting surfaces are abrased to remove the oxide layer and immediate connection, often using a special contact lubricant to exclude contact with air, is required to avoid the oxide layer reforming. Therefore producing, maintaining or otherwise working with switch boards using known naked aluminium busbars requires additional skills and time consuming measures when compared with a copper busbar equivalent.

The present invention attempts to provide a useful alternative to the aforementioned prior art aluminium and copper busbars.

It is an object of the present invention to provide a pre-insulated busbar comprising a conductive barrier for limiting oxide layers forming on the busbar.

It is a further object of the present invention to provide a pre-insulated busbar enabling improved electrical connectivity and corrosion resistance when connected with dissimilar metals.

It is a further object of the present invention to provide a pre-insulated aluminium busbar having improved electrical connectivity and corrosion resistance when connecting to other busbars or electrical components.

It is a further object of the present invention to provide a pre-insulated busbar that comprises an electrically insulating barrier that is selectively removable from the busbar.

It is a yet a further object of the present invention to provide a pre-insulated busbar capable of being shaped without compromising the efficacy of the electrical insulation barrier.

It is an object of the present invention to provide a pre-insulated busbar enabling safer, simpler and faster electrical connections than existing naked busbars.

### SUMMARY OF THE INVENTION

In accordance with a first aspect of the present invention there is provided an insulated busbar for use in electrical distribution, the busbar comprising a metallic body having at least an external surface disposed between peripheral ends, characterised in that, the busbar comprises a substantially electrically insulating barrier covering at least a portion of the external surface for limiting an undesired electrical connection with the exterior surface.

Preferably the insulating barrier comprises a plastic surface coating.

Preferably the plastic surface coating has ductile properties.

In accordance with a second aspect of the present invention there is provided an insulated busbar for use in electrical distribution, the busbar comprising a body having an exterior surface disposed between peripheral ends, characterised in that the busbar comprises a substantially electrically conductive barrier covering at least a portion of the external surface for limiting an undesired metallic oxide layer forming on the exterior surface.

Preferably the conductive barrier comprises a metallic surface coating.

In accordance with a further aspect of the present invention there is provided an insulated busbar for use in electrical distribution having a first portion and a second portion, characterised in that the first portion comprises the conductive barrier and the second portion comprises the insulating barrier.

In a preferred embodiment of the present invention the metallic surface coating comprises nickel material.

Preferably the plastic surface coating is applied to the busbar external surface using a powder coating process.

In a preferred embodiment the insulating barrier may be selectively removable from the exterior surface by scoring the plastic surface coating and peeling it away from the exterior surface. Preferably no plastic residue remains on an exposed external surface after the plastic surface coating has been removed.

Preferably the metallic surface coating and the plastic surface coatings limit marking of the busbar through handling.

Preferably the metallic surface coating and the plastic surface coating can be applied to a busbar prior to a shaping of the busbar in use.

### BRIEF DESCRIPTION OF THE DRAWINGS

The present invention will now be described, by way of example, with reference to the accompanying drawings, in which:

FIG. 1 shows an “L” shaped busbar in accordance with a preferred embodiment of the present invention; and

FIG. 2 shows a flat busbar in accordance with a preferred embodiment of the present invention.

### DESCRIPTION OF THE PREFERRED EMBODIMENTS

Referring to the Figures, there is shown a busbar 10 comprising a body 12 having an external surface 13 disposed between peripheral ends 6,8. The external surface 13 preferably comprises at least a first planar surface 14 and an opposed second planar surface 16, the first surface 14 and second surface 16 being spaced apart by an edge 18 corresponding to a thickness of the busbar 10.

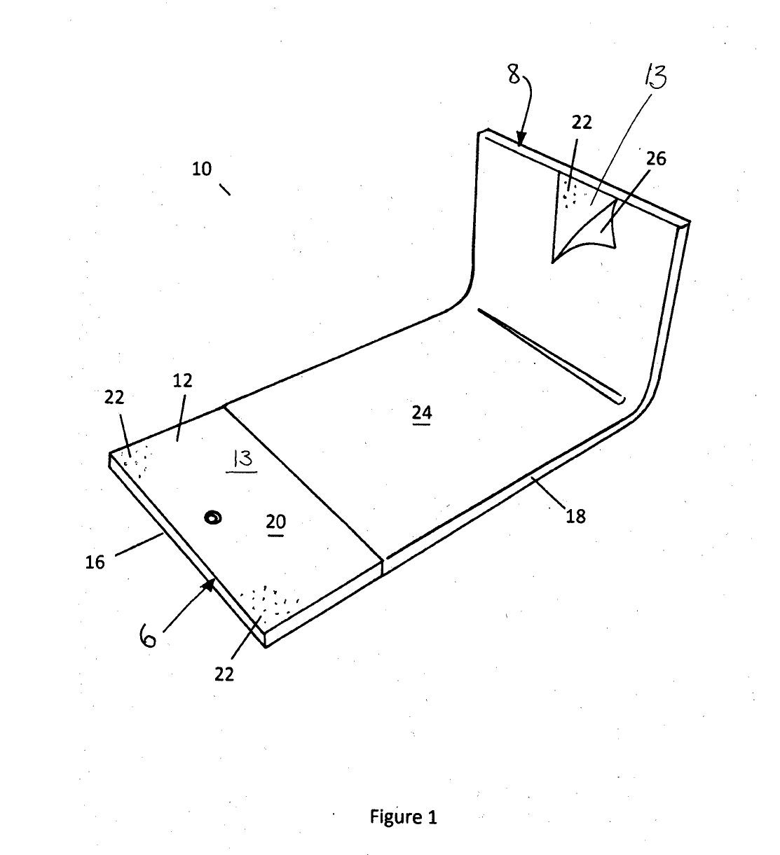

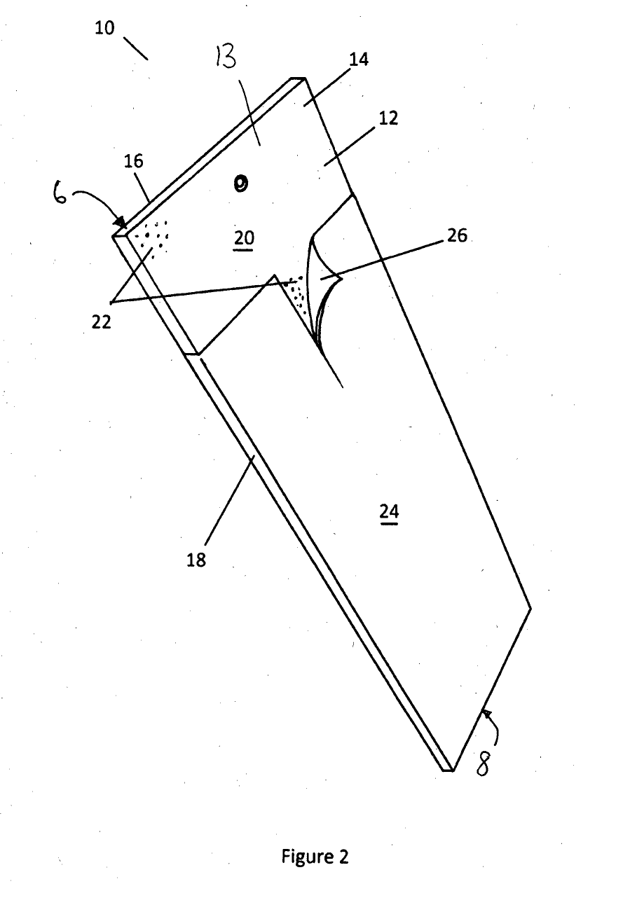

In the embodiment shown in FIG. 1 the busbar has an “L” shaped configured however it is to be understood that the busbar 10 of the present invention is not limited in shape and may take any particular shape or configuration as desired including a straight flat busbar 10 shown in FIG. 2. It is an advantage of the present invention that the busbar may be insulated prior to being shaped or bent or otherwise prepared as required for use with a particular electrical connection or electrical distribution apparatus.

It should be understood that the features of the present invention may be applied to a busbar either separately or in combination. Therefore, a busbar 10 according to the present invention may comprise an insulating barrier alone or together with a conductive barrier. Further, a busbar 10 may be provided having a conductive barrier alone.

In one preferred embodiment the busbar 10 comprises an aluminium material which is made from an electrical grade of aluminium having desired characteristics of bendability and mechanical strength. Typically a busbar 10 of aluminium material will comprise Alloy 6101 and a temper T6 giving the following typical material properties:
Electrical conductivity: 57% IACS (International Annealed Copper Standard)
Melting range: approximately 660° C.
Max. thermal capacity: 319 μΩ mm²
Thermal conductivity: 20.5/25 kgf/mm²

### Electrically Conductive Barrier

As shown in the figures the busbar 10 of the present invention is arranged to have a first portion 20 covered by an electrically conductive barrier 22. The conductive barrier 22 comprises a metallic surface coating 22 which is arranged to cover a portion 20 of the external surface 13. Preferably the first portion 20 may comprise a substantial entirety of the external surface 13.

It is to be understood that the metallic surface coating 22 is configured to limit a metallic oxide layer forming on the external surface 13 of the first portion 20 of the busbar 10. The metallic surface coating 22 preferably comprises the element nickel which, when applied in accordance with the present invention has been found to provide the following suitable characteristics:
Good adherence to the aluminium after proper preparation
Low electrical resistance
Compatible with copper, tin, silver and aluminium materials and coatings which are used for connections with the busbar.
Ductile, allowing the busbar to be bent without fracturing or compromising the nickel plated surface.

The metallic surface coating 22 may be applied by any known means but a preferred embodiment of the present invention involves an electrodeposition method.

In accordance with the present invention, a method of providing a metallic surface coating 22 on a busbar 10 made of aluminium material is described below.

### Mounting:

The busbar 10 is suspended on a mounting rack for the pre-treatment and electroplating processes.

### Cleaning:

The busbar 10 is immersed for a period of time in a heated cleaner solution for the removal of surface impurities such as oils, grease or other compounds. Typically the busbar 10 will be immersed in a hot chemical solution for a period of 12 minutes. The chemical solution described for cleaning may comprise a solution of Oxidite C-10 at a temperature of 60° C.

The cleaned busbar 10 is then immersed or spray rinsed in demineralised water.

### Etching:

The portion 20 of the busbar 10 is immersed for a period of time in a heated etching solution for the removal of surface material from the busbar 10. Typically the busbar 10 will be immersed for a period of around 2 minutes. The etching solution described may comprise a solution of Enprep 250 at a temperature of 60° C.

The etched busbar 10 is then immersed or spray rinsed in demineralised water.

### Smut Removal:

The busbar 10 is immersed in a smut removal solution for the removal of any residue cleaner/etcher solution and to ensure the busbar 10 surface material is ‘active’ for subsequent processes. The smut removal solution described may comprise a solution of Victa-D-Ox at room temperature.

The busbar 10 is then immersed or spray rinsed in demineralised water.

### Initial Zinc Plating:

The portion 20 of the busbar 10 is immersed for a period of time in a zincating solution for depositing a zinc layer on the surface 13 of the busbar 10 for providing good adhesion with nickel in subsequent steps. Typically the busbar 10 will be immersed in the zincating solution for a period of around 2 minutes. The initial zincating solution described may comprise a solution of Bondal at a temperature of 30° C.

The busbar 10 is then immersed or spray rinsed in demineralised water.

The portion 20 of the busbar 10 is then immersed into a zincate strip solution for lightly etching the deposited zinc layer and for exposing areas on the surface 13 of the busbar 10 not yet completely covered by the deposited zinc. The zincate strip solution described may comprise a solution of Alprep 291 at a temperature of 30° C.

The busbar 10 is then immersed or spray rinsed in demineralised water.

### Final Zinc Plating:

The portion 20 of the busbar 10 is immersed into a final zincate solution to complete the zinc layer which improves adherence between the busbar 10 surface 13 and a subsequent nickel sulphamate solution. It also limits the sacrificial nature of the aluminium material due to the position of metal on the galvanic scale. The final zincate solution described may comprise a solution of Bondal at a temperature of 30° C.

The busbar 10 is then immersed or spray rinsed in demineralised water.

### Nickel Electroplating:

The portion 20 of the busbar 10 is immersed with a live electrical charge into a bath of nickel sulphamate solution. A boric acid bath of 45 g/l boric acid at a preferred temperature of around 50° C. is required for this process. The actual operating conditions for depositing of the nickel may vary however the preferred embodiment applies approximately 200 amperes for each busbar 10 to achieve an electrodeposition of nickel onto the busbar 10 surface 13. The nickel coating preferably provides an insulating barrier 22 having a thickness of approximately 10 μm after a 10 to 15 minute period of time. The nickel sulphamate solution described may comprise a Barrett Sn solution.

Typically the nickel coating produces a semi-matte finish on the external surface 13 of a busbar 10. However it is found that this semi-matte finish marks easily through subsequent handling of the busbar 10.

### Further Non-Marking Step

To overcome the problem of marking the semi-matte finish merely through handling a further non-marking step may be included in the method of the present invention. The further non-marking step comprises an additional immersion of a nickel plated busbar 10.

This further step is advantageously found to improve corrosion resistance of the busbar 10 and to limit marking of the nickel finish. Also, it has been advantageously found to improve the amount of adhesion between the insulating barrier 26 and the exterior surface 13.

The insulating barrier 26 in accordance with the present invention can provide over 96 hours of salt spray protection without changing the colour of the busbar 10 or effecting the resistance in a busbar 10 connection.

### Electrically Insulating Barrier

In accordance with a preferred embodiment of the present invention seen in FIGS. 1 and 2 the busbar 10 comprises an electrically insulating barrier 26 disposed about the second portion 24 of the busbar 10. The insulating barrier 26 comprises a plastic surface coating 26 that is arranged to substantially cover at least a portion of the external surface 13 area as defined by the second portion 24. It is to be understood that the plastic surface coating 26 is configured to be substantially ductile and have substantially electrically insulating properties.

It should be understood that the electrically insulating barrier 26 may be equally effective for insulating a busbar 10 made from either aluminium or copper material. The plastic material used as the surface coating 26 preferably comprises an epoxy thermoset material that provides a plastic surface coating 26 substantially covering the second portion 24 and which has sufficient ductibility to conform to the shape of the busbar 10 before, during and after shaping of the busbar without compromising the insulation properties of the barrier.

A method of providing a plastic surface coating on a busbar 10 in accordance with a preferred embodiment of the present invention is described below.

### Aluminium Material Busbars:

An aluminium busbar 10 is suspended on a mounting rack for pre-treatment and the powder coating processes.

A busbar 10 of aluminium material is immersed and/or spray rinsed in a demineralised water to remove any excess solution (remaining from the metallic surface coating process).

The portion 24 of the busbar is immersed and/or sprayed with a passivation solution to prevent marking as well as adding a layer that provides adhesion for the powder coating process described in the following steps. Typically this passivation solution is a water based lacquer such as Hydroclear at room temperature.

The busbar is then heated to around 60° C. to harden the lacquer in preparation for handling and/or the subsequent powder coating process.

### Copper Material Busbars Pre-Treatment:

A busbar 10 of copper material is suspended on a mounting rack for pre-treatment and the powder-coating process.

The busbar 10 is immersed in cleaner solution (such as Hullclean 810 at 60° C.) to ensure the copper surface 13 is clean and active for subsequent steps by removal of any soil/grease etc from the busbar 10 surface 13.

The busbar 10 is immersed and/or spray rinsed in a demineralised water to remove excess cleaner solution.

The busbar 10 is then immersed and/or sprayed with a solution to prevent marking as well as adding a layer that provides adhesion for the powder coating process described in the following. Typically this solution comprises a water based lacquer such as Hydroclear at room temperature.

The plastic surface coating 26 may comprise a thermoset plastic material which can be applied to the busbar 10 second portion 24 using powder coating surface treating techniques. Preferably the method of producing an insulating barrier 26 in accordance with the present invention uses a fluidised process comprising at least the following steps:

### Mounting:

The busbar 10 (of either aluminium or copper material) undergoing treatment is mounted on a jig or rack for improved handling and is then heated to around 180° C.

### Coating:

Once the busbar 10 is heated the portion 24 is immersed into a powder fluidised bed for around 5-8 seconds thereby providing the portion 24 of the busbar 10 with a coating of uncured powder.

### Curing:

The busbar 10, coated with the uncured powder, is then baked for around 30 minutes at a temperature of 150° C. to cure the powder coating and achieve the plastic surface coating 26.

In an alternate process a hot flocking process may be used to apply the plastic surface coating 26.

It should be understood that the plastic surface coating 26 provides an effective electrically insulating barrier which, in practice, complies with relevant standards, such as national AS/NZS standards or the IEC (International Electrotechnical Commission) equivalents. These standards set guidelines and rules in respect of desirable material properties with particular regard given to insulation resistance, flammability rating and temperature endurance for example.

Some further advantageous features of the insulating plastic surface coating 26 in accordance with the present invention are as follows:
Lower cost of busbar 10 insulation when compared with known methods;
The insulated busbars 10 can be cut, holes punched or drilled, and bent as required;
Areas covered by the plastic surface coating 26 are selectively accessible by scoring and peeling the plastic surface coating 26 away from the busbar 10 thereby exposing the external surface 13 beneath;
Provides greater durability than known heat shrink methods;
Provides compact insulation with less impact on the dimensions of a busbar 10 than known PVC sleeving methods; and
Tough, chip resistant, water resistant and provides improved corrosion protection.

The plastic surface coating 26 provides a busbar 10 that does not require additional time to be spent on fitting insulation materials to the switchboard or the busbar before or after installation of a busbar 10. The present invention allows a switch board builder to design and manufacture an insulated switch board system in much less time than is required with known busbars.

In general the quality of a powder coating is normally measured by the quality of adhesion with the base material and by the properties of hardness or durability of a coating. However it is to be understood that the present invention requires only that the plastic surface coating 26 has sufficient adhesion with the external surface 13 of portion 24 to remain in place on the busbar 10 during shaping and use of the busbar 10. When undergoing shaping as required for a particular switch board or other electrical distribution apparatus. The coating 26 is to be sufficiently ductile to avoid being compromised by fracturing, splitting or cracking for example when the busbar 10 is worked upon.

The plastic surface coating 26 in accordance with the present invention has sufficient ductile properties to permit a busbar 10 to be bent at an angle of 90° as seen in FIG. 1 or more from beginning as a flat configuration shown in FIG. 2, without compromising the insulating properties of the plastic surface coating 26 in any way.

Further, as shown in FIGS. 1 and 2 the plastic surface coating 26 is arranged to be of a suitable plasticity/ductility to enable at least a portion of the plastic surface coating 26 to be selectively peeled away from the surface of the busbar 10 as may be required to make a new connection for example. It is an advantage of the present invention that an area of the external surface 13 from which the plastic surface coating 26 has been removed remains clean and without any surface coating 26 residue.

In a preferred embodiment of the present invention the plastic surface coating 26 is applied subsequent to the application of the metallic surface coating 22.

In use, a busbar 10 in accordance with the present invention will be provided for commerce and to electrical distributors and the like. In one preferred embodiment a busbar 10 of aluminium material is provided having the metallic and plastic surface coatings 22, 26 thereon as described hereinbefore, or alternatively, a busbar 10 of copper material having a plastic surface coating 26 on a portion thereof may be provided. The busbar 10 will be available in all the industry standard sizes.

A user, such as a switch board designer or electrician for example can manipulate or shape the busbar 10 according to the present invention as required for any particular electrical distribution application as is known in the art. An advantage of the busbar 10 of the present invention lies in the pre-insulated feature of the busbar 10 such that the user can shape and fit the busbar 10 without further concern or additional steps relating to insulating of the busbar 10.

After selecting a busbar 10 of suitable dimensions the user can proceed to fit the busbar 10 by shaping or bending the busbar 10 to suit the electrical apparatus or switch board dimensions. The busbar 10 can be further adapted by drilling holes for connection with other electrical components such as other busbars 10 or wiring for example as is known in the art. Where a position for a desired hole or connection is disposed in the second portion 24 and therefore covered by the plastic second surface coating 26 the coating 26 can be selectively removed from the area by suitable means, such as by marking the coating 26 with a scribe or similar tool and then manually peeling the plastic surface coating 26 away from the busbar 10 by hand, as indicated in FIG. 2.

Once the busbar 10 has been adapted to conform to an electrical apparatus it may then be fitted in position by known means such as bolting or clamping. A contact lubricant may improve the performance of an electrical connection regardless of the type of metal used in a busbar, therefore it is envisaged that contact lubricants may be used with the present invention.

Modifications and variations as would be apparent to a skilled addressee are deemed to be within the scope of the present invention.

1. A pre-insulated busbar, for use in the distribution of electricity, the pre-insulated busbar comprising:
an electrically conductive metallic body having at least an external surface disposed between peripheral ends, and
a substantially ductile electrically insulating barrier disposed to overlay at least a portion of the external surface for substantially isolating a portion underlying the insulating barrier from an electrical contact,
wherein a structural integrity and insulating function of the overlaying insulating barrier is configured to be maintained during a substantial deformation of the underlying the portion of the metallic body.

2. A pre-insulated busbar according to claim 1, wherein the substantial deformation comprises a bending of the portion through an angle up to 90°.

3. A pre-insulated busbar according to claim 1, wherein the substantially ductile insulating barrier comprises a surface coating of an epoxy thermoset material.

4. A pre-insulated busbar according to claim 1, wherein at least a portion of the insulating barrier is selectively removable from the external surface.

5. A pre-insulated busbar according to claim 4, wherein the insulating barrier is selectively removable by scoring the insulating barrier to define an outline of an underlying external surface to be exposed and peeling the portion of the insulating barrier defined by the outline away from the metallic body to expose the underlying external surface.

6. A pre-insulated busbar according to claim 1, wherein the insulating barrier comprises a thickness greater than 0.02 mm.

7. A pre-insulated busbar according to claim 1, wherein the metallic body comprises an L shaped configuration.

8. A pre-insulated busbar according to claim 1, wherein the metallic body further comprises a conductive barrier disposed about at least a portion of the external surface 13, wherein the conductive barrier substantially limits a formation of a metallic oxide layer upon the metallic body.

9. A pre-insulated busbar according to claim 8, wherein the conductive barrier comprises a metallic surface coating.

10. A pre-insulated busbar according to claim 8, wherein the conductive barrier comprises a nickel material.

11. A pre-insulated busbar according to claim 1, wherein the metallic body comprises an aluminum material.

12. A pre-insulated busbar according to claim 8, wherein the portion substantially comprises the entire external surface.

13. A pre-insulated busbar according to claim 9, wherein the metallic surface coating comprises a thickness between 0.5 μm to 15 μm.

14. A pre-insulated busbar according to claim 8, wherein the metallic body is configured to be shaped while maintaining a structural integrity and conductive function of the conductive barrier thereon.

15. A pre-insulated busbar according to claim 8, wherein the portion of the exterior surface and the portion a portion underlying the insulating barrier overlay one another.

16. A pre-insulated busbar according to claim 15, wherein an adhesion between the insulating barrier and the metallic body is substantially improved about the overlay.

17. A method of manufacturing a pre-insulated busbar, the pre-insulated busbar comprising a substantially ductile electrically insulating plastic barrier thereon, for use in the distribution of electricity, the method comprising:
providing an electrically conductive metallic body having an external surface disposed between peripheral ends;
heating the metallic body to a temperature between 140° C. and 200° C.;
immersing at least a portion of the heated metallic body into a powder fluidized bed for a period of 3 to 10 seconds; and
baking the metallic body at a temperature between 130° C. and 170° C. for a period of time greater than 20 minutes.

18. A method of pre-treating a busbar, for providing a conductive surface coating upon an external surface of the busbar for limiting a formation of an oxide layer, the method comprising:
providing a busbar of aluminium or copper metal;
cleaning the busbar of surface impurities though immersion of the busbar into a chemical solution of Oxidite C-10 at a temperature between 40° C. and 80° C. for a period of between 6 minutes to 18 minutes;
etching the external surface through immersion of the busbar into a chemical solution of Enprep 250 at a temperature between 40° C. and 80° C. for a period of 1 to 5 minutes;
removing smut from the external surface 13 through immersion of the busbar into a chemical solution of Victa-D-Ox at ambient temperature;
providing an initial Zinc plating on the external surface through immersion of the busbar into a zincating solution of Bondal at a temperature of 20° C. to 40° C. for a period of 1 to 5 minutes;
etching the initial Zinc plating through immersion of the busbar into a chemical solution of Alprep 291 at a temperature of 20° C. to 40° C.;
providing a final Zinc plating of the external surface through immersion of the busbar into a zincating solution of Bondal at a temperature of 20° C. to 40° C.; and,
electroplating of the busbar with a Nickel layer through immersion of the Zinc plated busbar with a live electrical charge of around 200 amperes into a bath of between 30 g/l to 50 g/l Boric acid at a temperature of between 40° C. to 60° C. for a period of 10 to 15 minutes.

19. A method of pre-treating a busbar according to claim 18, wherein the method further comprises:
providing a protective non-marking coating through a repetition of the electroplating step.
